(19) United States
(12) Patent Application Publication
(10) Pub. No.: US 2009/0103938 A1
(43) Pub. Date: Apr. 23, 2009

(54) Image Forming Apparatus

(76) Inventor: Tomohiro Kiriyama, Yamanashi-shi (JP)

Correspondence Address: Cameron Kerrigan;Squire, Sanders & Dempsey L.L.P., Suite 300, One Maritime Plaza, San Francisco, CA, 94111, US

(21) Appl. No.: 12/036,987

(22) Filed: Feb. 25, 2008

(30) Foreign Application Priority Data
Oct. 22, 2007 (JP) 2007-273508

(51) Int. Cl. G03G 15/00

(52) U.S. Cl. 399/82

(57) ABSTRACT

Disclosed is an image forming apparatus which forms an image on a paper including an image forming unit to form the image, a plurality of paper feeding trays to store the paper, a storage unit to store information of a paper direction of the paper for each of the paper feeding trays and a control unit to select one paper feeding tray among the plurality of paper feeding trays based on information of an post-processing mode set for a job and the information of the paper direction of the paper for each of the paper feeding trays.

### BACKGROUND OF THE INVENTION

1. Field of the Invention

The present invention relates to an image forming apparatus.

2. Description of Related Art

Recently, many of the papers on which an image is to be formed by image forming apparatuses such as a copier, a printer and the like have same laid direction or fiber direction (hereinafter, called paper direction) of the paper with respect to the longitudinal direction or the short-hand direction of the paper according to the condition of the manufacturing process of the paper.

According to JP5-327948A, an image forming apparatus which stores paper direction information of the paper so as to correspond to the paper size, which accepts the input of the paper size, and which forms the information of the paper direction which corresponds to the size which is input on the paper is disclosed because the paper direction of the paper is difficult for a user to discriminate at one glance.

However, in the prior art, the information of the paper direction is corresponded to the paper size. Therefore, when the paper is in the same size but has different paper direction, the paper cannot be responded.

The paper has characteristics that it is difficult to be bent and be folded in the direction which is orthogonal to the paper direction and that it is easily bent and folded in the direction parallel to the paper direction. Therefore, when the post-processing which is to be executed after the image forming, for example, the binding process, is executed, a problem that the booklet which is made without being conscious about the paper direction may be difficult to open or may be easily deformed occurs.

The image forming apparatus includes the APS (automatic paper selecting) function, that is, the function to automatically select the paper and the ATS (automatic tray switching) function, that is, the function to automatically switch the paper feeding tray when the paper runs out during the image forming. The image forming apparatus having such functions does not consider the paper direction of the paper as the determination condition for selection when selecting paper. Therefore, problems that the paper having the paper direction which is not suitable for the post-processing is selected and that the quality of the paper after the post-processing deteriorates occur.

### SUMMARY OF THE INVENTION

In view of the above problems, a main object of the present invention is to realize the selecting of the paper which has the paper direction suitable for the post-processing and to assure the quality of the paper in which the post-processing is done.

To achieve at least one of the above-described objects, an image forming apparatus which forms an image on a paper reflecting on aspect of the invention comprises an image forming unit to form the image, a plurality of paper feeding trays to store the paper, a storage unit to store information of a paper direction of the paper for each of the paper feeding trays, and a control unit to select one paper feeding tray among the plurality of paper feeding trays based on information of an post-processing mode set for a job and the information of the paper direction of the paper for each of the paper feeding trays.

### BRIEF DESCRIPTION OF THE DRAWINGS

The present invention will become more fully understood from the detailed description given hereinbelow and the appended drawings, and thus are not intended as a definition of the limits of the present invention, and wherein:

FIG. 1 is a schematic cross-sectional diagram of an image forming apparatus;

FIG. 2 is a view showing an example of a paper feeding tray setting screen;

FIG. 3 is a control block diagram of the image forming apparatus;

FIG. 4 is a flow chart of a setting process of the paper feeding tray;

FIG. 5 is a main flow chart of a paper feeding process;

FIG. 6 is a flow chart of the first paper feeding tray selecting process; and

FIG. 7 is a flowchart of the second paper feeding tray selecting process.

### DESCRIPTION OF THE PREFERRED EMBODIMENTS

Hereinafter, the embodiment of the present invention will be described in detail with reference to the drawings.

First, the structure will be described.

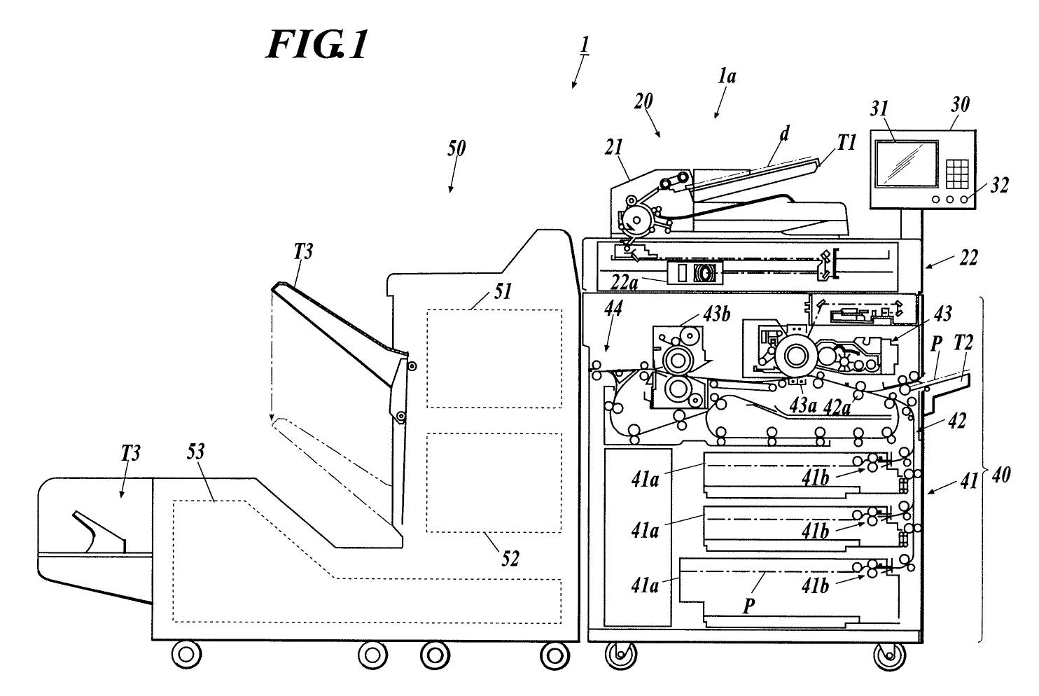

The schematic cross-sectional diagram of the image forming apparatus 1 is shown in FIG. 1.

The image forming apparatus 1 is a digital multi functional peripheral comprising an image forming unit which reads an image from a document and forms the read image on the paper P and which receives a job which includes the image data from the outside device or the like and forms the image on the paper P based on the job, an post-processing unit which carries out the post-processings such as a stapling process, a folding process, a bookbinding process and the like to the paper on which the image is formed, and the like. As shown in FIG. 1, the image forming apparatus 1 comprises a main body unit 10 which includes an image reading unit 20, an operation display unit 30 and a print unit 40 and an post-processing unit 50.

The image reading unit 20 comprises an automatic document sending unit 21 which is called the ADF (Auto Document Feeder) and a reading unit 22. The document d which is mounted on the document tray T1 of the automatic document sending unit 21 is carried onto the contact glass which is the reading position of the reading unit 22, the document d is exposed by the optical system of the reading unit 22, and the image of the document d is read by the CCD (Charge Coupled Device) 22a. Here, the image is not limited to the image data such as graphics and photographs, and the image includes the text data and the like such as letters, symbols and the like.

The image (analog image signal) which is read by the reading unit 22 is output to the after mentioned control unit, and is output to the print unit 40 after being A/D converted and various types of image processes are carried out in the control unit.

The operation display unit 30 comprises the LCD (Liquid Crystal Display), a touch panel 31 which is provided so as to cover the LCD and a group of operation keys which are not shown in the drawing. The operation display unit 30 accepts an input by a user and outputs the input information to the control unit, and displays various types of setting screens, various types of processing results and the like to input various types of setting conditions according to the display signal which is input from the control unit.

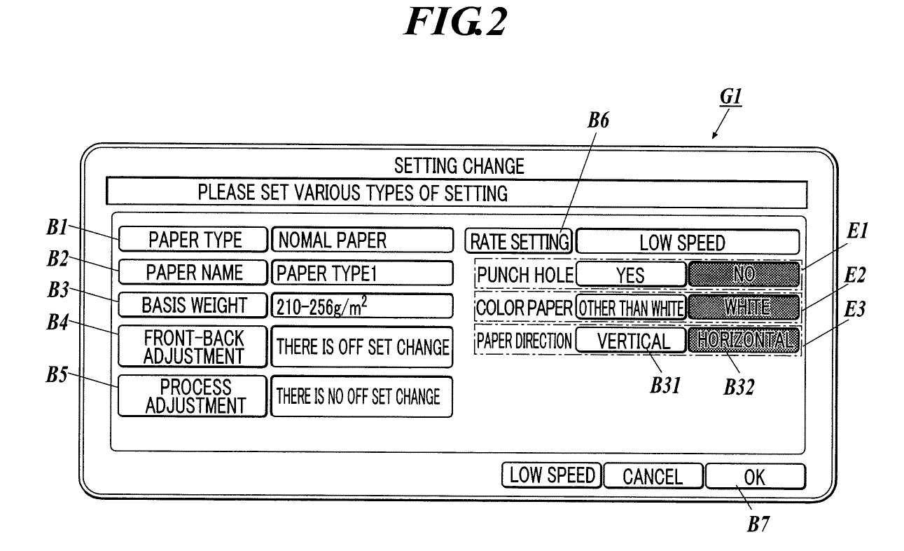

On the touch panel 31 of the operation display unit 30 according to the embodiment, the paper feeding tray setting screen G1 to set the information of the paper which is to be stored in each paper feeding tray provided in the image forming apparatus 1 is displayed. FIG. 2 shows an example of the paper feeding tray setting screen G1 to be displayed on the touch panel 31.

As shown in FIG. 2, the paper feeding tray setting screen G1 is a screen which receives the setting of the information of the paper which is stored in the paper feeding tray to the paper feeding tray which is selected in the screen (not shown in the drawing) superordinate than the paper feeding tray setting screen G1, and the paper feeding tray setting screen G1 comprises a paper type setting button B1, a paper name setting button B2, a basis weight setting button B3, a front-back adjustment button B4, a process adjustment button B5, a rate setting button B6, a punch hole setting area E1, a color paper setting area E2, a paper direction setting area E3, an OK button B7 and the like. When the OK button B7 is pushed, the information which is set in the paper feeding tray setting screen G1 is output to and stored in the control unit.

The paper direction setting area E3 comprises a vertical button B31 to accept the setting of vertical as the paper direction of the paper and a horizontal button B32 to accept the setting of horizontal as the paper direction of the paper, and the paper direction setting area E3 functions as an input unit to accept the setting of the paper direction of the paper (vertical direction or horizontal direction).

The print unit 40 carries out the electrographic type image forming based on the input print data, and the print unit 40 comprises a paper feeding unit 41, a paper feeding carrier unit 42, the image forming unit 43 and the carrying out unit 44.

The paper feeding unit 41 comprises a plurality of paper feeding trays 41a, a paper feeding unit 41b, a manual tray T2 and the like. Each paper feeding tray 41a contains the paper P which is identified according to the paper direction and the size in advance, and the paper P is carried toward the paper feeding carrier unit 42 one by one from the top by the paper feeding unit 41b. Further, a paper presence/absence sensor to detect whether paper is contained or not and a size detection sensor to detect the size of the contained paper and the like are provided at each paper feeding tray 41a and the manual tray T2, and the detection signal from the sensors are output to the after mentioned control unit. The control unit determined the presence/absence/of the paper and the paper size based on the detection signals.

The paper feeding carrier unit 42 carries the paper P which is carried from the paper feeding tray 41a or the manual tray T2 to the transfer device 43a via a plurality of intermediated rollers, a resist roller 42a and the like. Moreover, the paper feeding carrier unit 42 carries the paper P on which an image is formed on one side thereof to the both side carrier path by the carrier path switching board, and carries the paper P to the transfer device 43a via the intermediate rollers and the resist roller 42a again.

The image forming unit 43 comprises a photoconductive drum, a charging device, an exposure device including a laser output unit to output laser beam based on the image data and a polygon mirror to allow the laser beam scan in the main scanning direction, a development device, a transfer device 43a, a cleaning unit and a fixing device 43b. Particularly, an electrostatic latent image is formed by the exposure device emitting the laser beam to the photoconductive drum which is charged by the charging device. Then, the development device develops the electrostatic latent image which is formed on the photoconductive drum by toner and forms the toner image. The toner image which is formed on the photoconductive drum by the development device is transferred to the paper P in the transfer device 43a. Further, the residual toner and the like on the surface of the photoconductive drum is removed by the cleaning unit after the toner image is transferred to the paper P.

The fixing device 43b carries out the heat fixing to the toner image which is transferred to the paper P. The paper P in which the fixing process is carried out is sandwiched by the paper ejection rollers of the carry out unit 44 and is carried to the post-processing unit 50 from exist.

The post-processing unit 50 comprises the post-processing unit such as the stapling unit 51 which binds a bundle of papers, the folding unit 52 which carries out the folding process to the paper, the bookbinding unit 53 which carries out the bookbinding process in which a booklet is made by applying a cover paper to a bundle of papers and the like, and executes various types of post-processes based on the post-processing mode which is instructed by the main body unit 10. The paper in which various types of post-processes are carried out or the paper in which the post-processing is not carried out is ejected to the paper ejection tray T3.

As for the post-processing mode, the binding mode to bind a bundle of papers, a folding mode to fold the paper in a predetermined form, a bookbinding mode to make a booklet from a bundle of papers and the like are suggested.

As for the binding mode, a side stitching mode in which the edge of the bundle of papers is bound and a saddle stitching mode in which the center of the papers is bound and folded in order to form a double spread booklet are suggested.

The folding mode is a process in which the paper is folded in a direction orthogonal to the longitudinal direction of the paper, and various types of modes in which the folding shapes are different such as a Z folding, an inside three fold, an outside three fold, a double parallel, an inside fold, a gate fold, an overlap three fold, an overlap inside fold and the like are suggested.

As for the bookbinding mode, a body mode which forms a bundle of papers and a cover mode which applies a cover by wrapping the bundle of paper with the cover paper, and the like are suggested.

That is, the folding process in which a folding line is made in the direction orthogonal to the longitudinal direction of the paper is executed to the paper on which the image is formed based on the page data in which the saddle stitching mode, the folding mode and the cover mode are set in the post-processing unit 50.

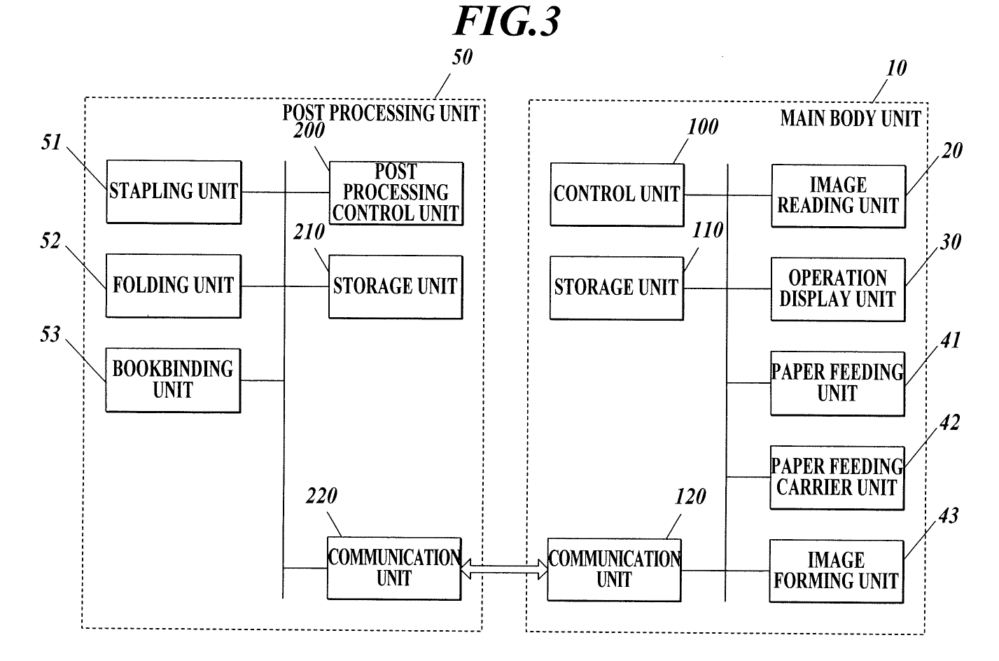

The control block diagram of the image forming apparatus 1 is shown in FIG. 3.

As shown in FIG. 3, the image forming apparatus 1 comprises the main body unit 10 and the post-processing unit 50 which is connected to the main body unit 10. Further, the image forming apparatus 1 may be connected to the outside device on the network (not shown in the drawing) so that the sending and receiving of the information can be carried out between one another.

The main body unit 10 comprises the image reading unit 20, the operation display unit 30, the paper feeding unit 41, the paper feeding carrier unit 42, the image forming unit 43, the control unit 100, the storage unit 110, the communication unit 120 and the like. Here, the same reference numerals as FIG. 1 are used for the structures which are the same as each unit described in FIG. 1, and the descriptions are omitted.

The control unit 100 comprises the CPU (Central Processing Unit), the ROM, the RAM and the like, and the control unit 100 reads the program stored in the ROM and expands the program in the control unit 100 or in the RAM and integrally controls various types of processes and each unit of the image forming apparatus 1 by cooperating with the expanded program. For example, the control unit 100 switches the copy mode, the print mode and the scan mode and controls the copying, the printing and the reading of the image data according to the instruction signal which is input from the operation display unit 30 and the outside device.

The control unit 100 reads the paper feeding tray information setting process program from the storage unit 110, reads the detection signal which is detected by various types of sensors which are provided at each paper feeding tray, and reads the information and the like which are set in the paper feeding tray setting screen G1, and the control unit 100 stores various typed of setting information including the size and the paper direction of the container paper by corresponding the information to each paper feeding tray by cooperating with the program and various types of data.

The control unit 100 reads the paper feeding process program according to the embodiment from the storage unit 110 and various types of data and the like relating to the data and jobs needed for the execution of the paper feeding process program from the storage unit 110, and realizes the function as a control unit which controls the process of selecting either of the paper feeding trays and allowing the paper feeding tray to feed paper based on the post-processing mode set for the job and the paper direction information set for each paper feeding tray, which is stored in the storage unit 110, by cooperating with the program and various types of data.

The job of the embodiment includes a plurality of page data, and the image data, the information of type and size of the paper and the information of post-processing mode are set for each page data.

More particularly, the control unit 100 determines the paper direction of the paper of the page data based on the information of post-processing mode of the page data and selects the paper feeding tray in which the paper with the paper direction which matches the determined paper direction is stored when the control unit 100 executes the paper feeding process.

The storage unit 110 is constituted of a non-volatile storage medium which can electrically delete and rewrite, which is constituted of a magnetic or an optical storage medium or a semiconductor memory. As for the storage unit 110, for example, the HDD (Hard Disk Drive), the EEPROM (Electrically Erasable and Programmable ROM), a flash memory and the like are suggested.

The storage unit 110 stores the data in which various types of setting information including the size and the paper direction of the paper which is contained in each paper feeding tray are corresponded and the job which is accepted from the operation display unit 30 and the outside device.

The communication unit 120 is constituted of a modem, the TA (Terminal Adapter), a router and the like. The communication unit 120 transmits the data of the paper to be carried out and the instruction data of the post-processing to the post-processing unit 50, and also receives the data which is transmitted from the post-processing unit 50 and controls the communication between the main body unit 10 and the post-processing unit 50.

The post-processing unit 50 comprises an post-processing unit which includes the stapling unit 51, the folding unit 52, the bookbinding unit 53 and the like, an post-processing control unit 200, a storage unit 210, a communication unit 220 and the like. Here, the same reference numerals are used for the structures which are same as each unit described in FIG. 1, and the descriptions are omitted.

The post-processing control unit 200 is constituted of the CPU, the ROM, the RAM and the like, and carries out a predetermined post-processing to the paper by driving and controlling each part according to the instruction data of the post-processing which is input from the control unit 100 of the main body unit 10 via the communication unit 220 and carries out the control to eject the paper in a predetermined paper ejection tray based on the program stored in the ROM.

The storage unit 210 stores various types of data to carry out the control of each unit of the post-processing unit 50.

The communication unit 220 is constituted of a modem, the TA (Terminal Adapter), a router and the like, and carries out the control of the communication between the post-processing unit 50 and the main body unit 10.

Next, the operation of the embodiment will be described.

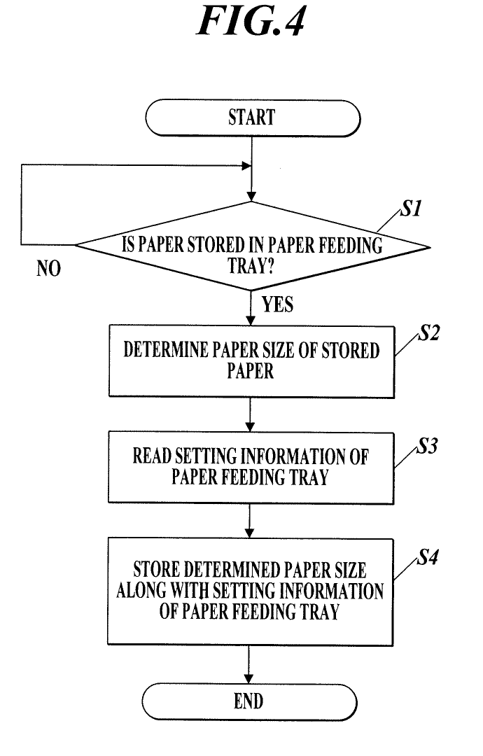

A flowchart of the setting process of the paper feeding tray according to the embodiment is shown in FIG. 4. Here, the flowchart shown in FIG. 4 is a process to be executed by the control unit 100 cooperating with the storage unit 110.

The control unit 100 determines whether a paper is stored in the paper feeding tray or not (step S1) based on the detection signal from the paper present/absent sensor which is provided at the paper feeding tray, and the process is returned to step S1 when the paper is not stored (step S1; No).

When the control unit 100 determines that the paper is stored in the paper feeding tray (step S1; Yes), the control unit 100 determines the size of the stored paper based on the detection signal from the size detection sensor (step S2).

The control unit 100 reads the paper direction information which is set for the paper feeding tray in the paper feeding tray setting screen G1 from the storage unit 110 (step S3), stores the size and the paper direction information of the determined paper in the storage unit 110 so as to correspond to the paper feeding tray (step S4), and the process is finished.

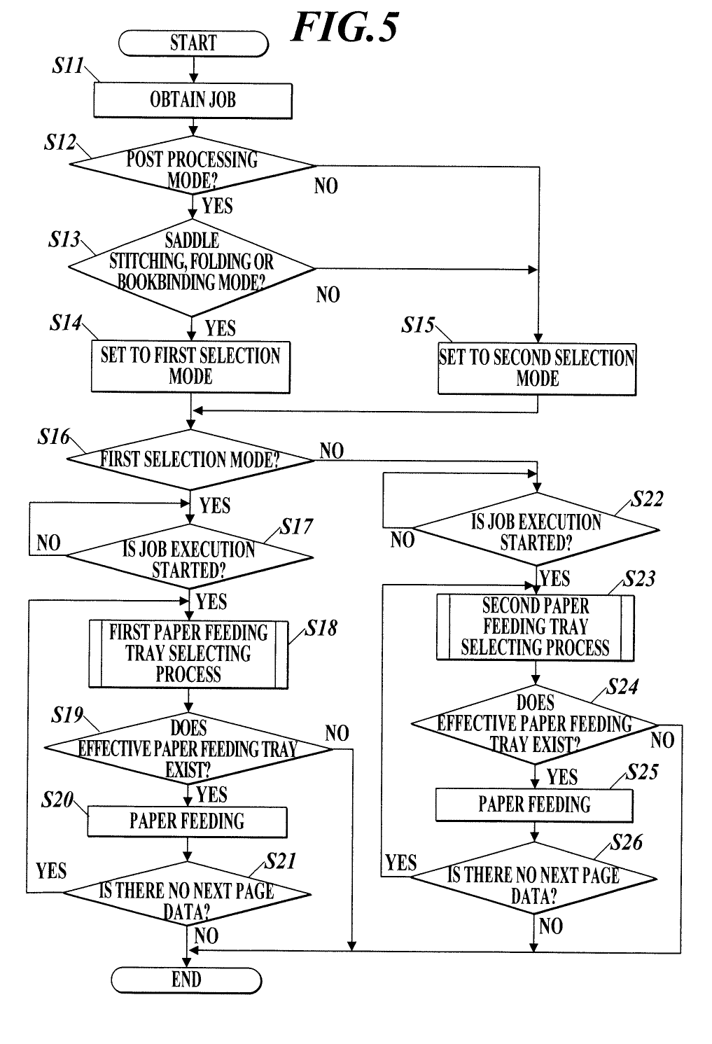

A flowchart of the paper feeding process according to the embodiment is shown in FIGS. 5 to 7. Here, the flowchart shown in FIGS. 5 to 7 is a process to be executed by the control unit 100 cooperating with the storage unit 110.

First, a description will be given by referring to the main flowchart of the paper feeding process shown in FIG. 5.

When the control unit 100 obtains a job (step S11), the control unit 100 determines whether the post-processing mode to execute the post-processing to the job is set or not (step S12).

When the post-processing mode is set (step S12; Yes), the control unit 100 determines whether the set post-processing mode is any one of the saddle stitching mode, the folding mode or the bookbinding mode or not (step S13).

When the post-processing mode is any one of the saddle stitching mode, the folding mode or the bookbinding mode (step S13; Yes), the control unit 100 sets to the first selection mode (step S14) and proceeds to step S16.

In the first selection mode, the control unit 100 sets the paper size and the paper direction information of the page data as the determination condition for selecting the paper feeding tray in the function (APS; auto paper selecting function) to automatically select the paper corresponding to the paper size of the page data or the function (ATS; auto tray switching function) to automatically switch the paper feeding tray when the paper runs out while the image forming is executed.

When the post-processing mode is not set (step S12; No) or when the post-processing mode is not any one of the saddle stitching mode, the folding mode or the bookbinding mode (step S13; No), the control unit 100 sets to the second selection mode (step S15) and proceeds to step S16.

In the second selection mode, the control unit 100 sets the information of the paper size of the page data as the determination condition for selecting the paper feeding tray in the APS or the ATS.

The control unit 100 determines whether the first selection mode is set or not (step S16). When the first selection mode is set (step S16; Yes), the control unit 100 determines whether the execution of the job is started or not (step S17), and the control unit 100 returns to step S17 when the execution of the job is not started (step S17; No).

When the execution of the job is started (step S17; Yes), the control unit 100 executes the first paper feeding tray selecting process (step S18), determines whether the paper feeding tray (effective paper feeding tray) which can feed paper exists or not (step S19), and finishes the process when the effective paper feeding tray does not exist (step S19; No).

When the effective paper feeding tray exists (step S19; Yes), the control unit 100 selects the effective paper feeding tray and feed paper from the selected paper feeding tray (step S20), determines whether there is the next page data or not (step S21), and returns to step S18 when there is the next page data (step S21; Yes). When there is no next page data (step S21; No), the control unit 100 finishes the process.

When the first selection mode is not set, that is, when the second selection mode is set (step S16; No), the control unit 100 determines whether the execution of the job is started or not (step S22) and returns to step S22 when the execution of the job is not started (step S22; No).

When the execution of the job is started (step S22; Yes), the control unit 100 executes the second paper feeding tray selecting process (step S23) and proceeds to step S24. Here, step S24 to step S26 is same as step S19 to step S21. Therefore, the description is omitted.

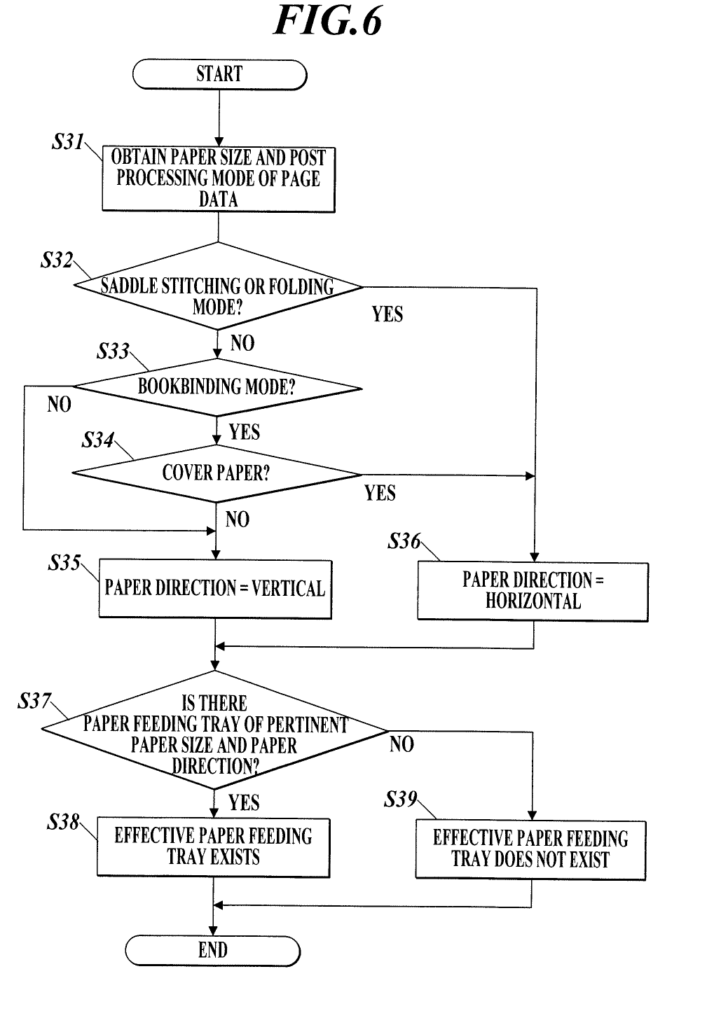

The flowchart of the first paper feeding tray selecting process to be executed in step S18 is shown in FIG. 6 and will be described.

The control unit 100 obtains the information of the type and size of the paper which is set in the predetermined page data (for example, the page data having the smallest identification number) among the unexecuted page data which is included in the job and the information of the post-processing mode (step S31), and determines whether the post-processing mode is the saddle stitching mode or the folding mode or not (step S32).

When the post-processing mode is not the saddle stitching mode or the folding mode (step S32; No), the control unit 100 determines whether the post-processing mode is the bookbinding mode or not (step S33).

When the post-processing mode is the bookbinding mode (step S33; Yes), the control unit 100 determines whether the type of the paper on which the image based on the image data of the page data is formed is the cover paper or not (step S34).

When the post-processing mode is not the bookbinding mode (step S33; No) or when the type of the paper is not the cover paper (step S34; No), the control unit 100 sets the paper direction of the paper to vertical (step S35).

When the post-processing mode is the saddle stitching mode or the folding mode (step S32; Yes) or when the type of the paper is the cover paper (step S34; Yes), the control unit 100 sets the paper direction of the paper to horizontal (step S36).

The control unit 100 compares the information (paper size and paper direction) which is set to each paper feeding tray stored in the storage unit 110 to the paper size obtained in step S31 and the paper direction set in step S35 or in step S36, that is, the paper size and the paper direction of the paper on which the image based on the image data of the page data is to be formed, and determines whether there is a paper feeding tray which stores the paper in which the paper size and the paper direction match the obtained paper size and the set paper direction (step S37).

When there is a paper feeding tray which matches with the paper size and the paper direction of the page data (step S37; Yes), the control unit 100 sets so as to indicate that the effective paper feeding tray which can feed papers exists (step S38) and finishes the present process.

The paper direction which is suitable for the post-processing mode can be set by step S37 and step S38 and the paper can be fed from the paper feeding tray which stores the paper in which the paper direction match with the set paper direction. Therefore, deterioration of quality of paper in which the post-processing is carried out due to the paper direction can be prevented.

When there is no paper feeding tray which stores the paper in which the paper size and the paper direction match with that of the page data (step S37; No), the control unit 100 sets so as to indicate that there is no paper feeding tray (effective paper feeding tray) which can feed paper (step S39) and finishes the process.

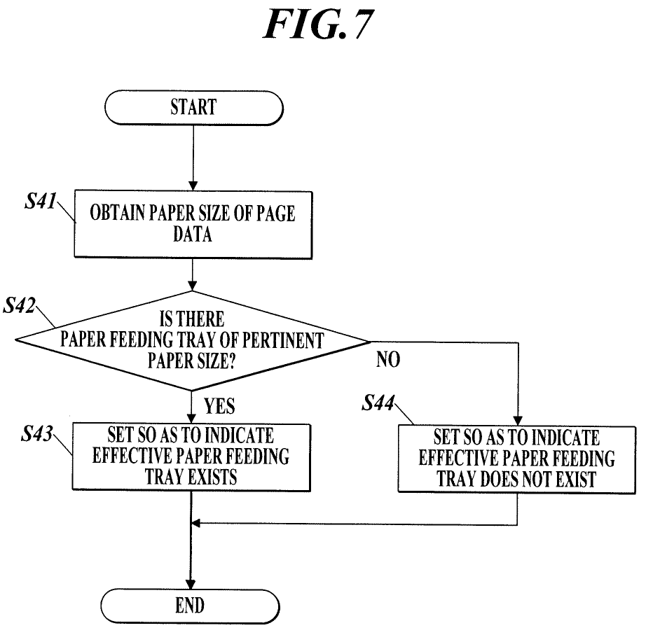

The flowchart of the second paper feeding tray selecting process to be executed in step S23 is described by FIG. 7.

The control unit 100 obtains the paper size which is set in the predetermined page data (for example, the page data having the smallest identification number) of the job (step S41).

The control unit 100 compares the information (paper size) set for each paper feeding tray stored in the storage unit 110 to the size of the paper obtained in step S41, that is, the size of the paper on which the image based on the image data of the page data is to be formed, and determines whether there is a paper feeding tray which stores the paper in which the size matches the obtained size or not (step S42).

When there is a paper feeding tray which stores the paper in which the size matches the size of the paper on which the image based on the image data of the page data is formed (step S42; Yes), the control unit 100 sets the matching paper feeding tray as the paper feeding tray (effective paper feeding tray) which can feed paper and sets so as to indicate that the effective paper feeding tray exists (step S43), and finishes the process.

When there is no paper feeding tray which stores the paper in which the size matches the size of the paper on which the image based on the image data of the page data is to be formed (step S42; No), the control unit 100 sets so as to indicate that the feeding tray (effective paper feeding tray) which can feed paper (step S44) does not exist, and finishes the process.

As described above, according to the embodiment, the paper feeding tray which feeds paper can be selected based on the information of the post-processing mode set to the paper on which the image based on the image data of each page data is formed and the information of the paper direction set for each paper feeding tray which stores the paper. Therefore, the paper feeding tray which feeds paper can be selected for each page data. Further, the horizontal direction paper in which the paper direction is in the direction orthogonal to the longitudinal direction of the paper can be fed as the paper in which the folding process of folding in the direction orthogonal to the longitudinal direction of the paper is to be carried out. Therefore, the folding direction is parallel to the paper direction and problems such that the formed booklet is difficult to open and the folding line is difficult to make and is easily deformable are difficult to occur. Thus, the selection of the paper in which the paper direction is suitable for the post-processing mode can be realized, and the quality of paper in which the post-processing is carried out can be assured.

Moreover, when the post-processing mode includes the folding process (in the case of the saddle stitching, the folding or the cover paper mode in the embodiment), the mode which includes the APS/ATS switching limitation to select the paper feeding tray to feed paper can be executed based on the paper direction determined based on the size and the post-processing mode of the paper on which the image based on the image data of the page data is to be formed and the size and the paper direction of the paper which is set for each paper feeding tray when the APS/ATS is executed. Therefore, the paper in which the paper direction is not suitable for the folding process can be prevented from being fed. Here, the conventional APS/ATS process can be executed when the folding process is not included. Therefore, the control time can be attempted to be reduced.

The present invention is not limited to the content of the above described embodiment, and can be arbitrarily changed within the scope of the invention.

According to a first aspect of the preferred embodiment of the present invention, there is provided an image forming apparatus which forms an image on a paper comprising an image forming unit to form the image, a plurality of paper feeding trays to store the paper, a storage unit to store information of a paper direction of the paper for each of the paper feeding trays, and a control unit to select one paper feeding tray among the plurality of paper feeding trays based on information of an post-processing mode set for a job and the information of the paper direction of the paper for each of the paper feeding trays.

In the image forming apparatus, one of the paper feeding trays can be selected among a plurality of paper feeding trays based on the post-processing mode and the paper direction which is set for each paper feeding tray. Therefore, the selection of the paper in which the paper direction is suitable for the post-processing can be realized, and the deterioration of the quality of the paper in which the post-processing is carried out due to the difference of paper direction can be prevented.

Preferably, the job has a page data including an image data and the information of the post-processing mode and the control unit selects ether one of the paper feeding tray among the plurality of paper feeding trays for each of the page data.

In the image forming apparatus, the paper feeding tray which feeds paper can be selected for each page data based on the information of the post-processing mode for the paper on which the image based on the image data of each page data is to be formed and the information of paper direction which is set for each paper feeding tray.

Preferably, the control unit determines the paper direction of the paper based on the information of the post-processing mode of the page data, and selects the paper feeding tray which stores the paper in which the paper direction matches with the determined paper direction.

In the image forming apparatus, the paper direction suitable for the post-processing mode can be set based on the post-processing mode and paper can be fed from the paper feeding tray which stores the paper in which the paper direction matches with the set paper direction. Therefore, the deterioration of the quality of paper in which the post-processing is carried out due to the paper direction can be prevented.

Preferably, when the post-processing mode set for the job is a mode including a folding process, the control unit selects the paper feeding tray based on information of a paper size and the post-processing mode of the page data and information of a paper size and the paper direction set for each of the paper feeding trays.

In the image forming apparatus, when the post-processing mode includes the folding process, the paper feeding tray which feeds paper can be selected based on the information of the size of the paper on which the image based on the image data of the page data is formed and the post-processing mode of the page data and the information of the size and the paper direction of the paper which is set for each paper feeding tray. Therefore, the paper in which the paper direction is not suitable for the folding process can be prevented from being fed.

Preferably, the image forming apparatus further comprising an input unit to accept a setting of the paper direction of the paper, and the storage unit stores the setting of the paper direction which is input from the input unit so as to correspond to the paper feeding tray.

In the image forming apparatus, setting of the paper direction of the paper stored in the paper feeding tray can be accepted.

The present U.S. patent application claims a priority under the Paris Convention of Japanese paten application No. 2007-273508 filed on Oct. 22, 2007, which shall be a basis of correction of an incorrect translation.

What is claimed is:

1. An image forming apparatus which forms an image on a paper, comprises:
an image forming unit to form the image;
a plurality of paper feeding trays to store the paper;
a storage unit to store information of a paper direction of the paper for each of the paper feeding trays; and
a control unit to select one paper feeding tray among the plurality of paper feeding trays based on information of an post-processing mode set for a job and the information of the paper direction of the paper for each of the paper feeding trays.

2. The image forming apparatus of claim 1, wherein
the job has a page data including an image data and the information of the post-processing mode, and the control unit selects ether one of the paper feeding tray among the plurality of paper feeding trays for each of the page data.

3. The image forming apparatus of claim 2, wherein
the control unit determines the paper direction of the paper based on the information of the post-processing mode of the page data, and selects the paper feeding tray which stores the paper in which the paper direction matches with the determined paper direction.

4. The image forming apparatus of claim 2, wherein
when the post-processing mode set for the job is a mode including a folding process, the control unit selects the paper feeding tray based on information of a paper size and the post-processing mode of the page data and information of a paper size and the paper direction set for each of the paper feeding trays.

5. The image forming apparatus of claim 1 further comprising an input unit to accept a setting of the paper direction of the paper, wherein
the storage unit stores the setting of the paper direction which is input from the input unit so as to correspond to the paper feeding tray.
